(19) United States
(12) Patent Application Publication
(10) Pub. No.: US 2015/0100439 A1
(43) Pub. Date: Apr. 9, 2015

(54) Workflow System

(71) Applicants: Jason Lu, Irvine, CA (US); Ocean S. Lu, Irvine, CA (US); Sky J. Lu, Irvine, CA (US)

(72) Inventors: Jason Lu, Irvine, CA (US); Ocean S. Lu, Irvine, CA (US); Sky J. Lu, Irvine, CA (US)

(21) Appl. No.: 14/049,205

(22) Filed: Oct. 8, 2013

(51) Int. Cl. G06Q 10/08; B25J 9/16; G06K 7/10; G06Q 50/12; H04W 4/00

(52) U.S. Cl. CPC G06Q 10/087; G06Q 50/12; H04W 4/008; G06K 7/10366; B25J 9/1602; Y10S 901/01
USPC 705/15; 340/10.1; 700/225; 901/1

(57) ABSTRACT

A workflow system for streamlining a sequence of connected steps between a plurality of parties in an organization, such as a restaurant. The parties have different, but interconnected roles. The communication system enables communication between the parties with wireless technology, such as radio frequency identification. Each party has a role in an organization. Each party comprises an attribute for defining the role. The attribute include a function, a position, and a location of each party. Each party has a tag, such as a radio frequency identification tag, for identification and accessing the attribute. The tag enables a transfer of data between the parties and a data storage portion. The data storage portion stores the attribute. The attribute is accessible by the parties. The attribute is viewed by predetermined parties through a communication device. A scanning device scans the tag to enable access and viewing of the attribute.

### CROSS-REFERENCE TO RELATED APPLICATIONS

Not applicable.

### RELATED CO-PENDING U.S. PATENT APPLICATIONS

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to a workflow system. More particularly, the invention relates to a workflow system that coordinates a plurality of parties in an organization to streamline functions.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that a restaurant is a business establishment which prepares and serves food and drink to customers in return for money, either paid before the meal, after the meal, or with a running tab. Meals are generally served and eaten on premises, but many restaurants also offer take-out and food delivery services.

Typically, radio-frequency identification (RFID) is the wireless non-contact use of radio-frequency electromagnetic fields to transfer data, for the purposes of automatically identifying and tracking tags attached to objects. The tags contain electronically stored information. Some tags are powered by and read at short ranges, such as a few meters, via magnetic fields. Unlike a bar tag, the RFID tag does not necessarily need to be within line of sight of the reader, and may be embedded in the tracked object.

It is known that near field communication (NFC) is a set of standards for smart phones and similar devices to establish radio communication with each other by touching them together or bringing them into close proximity, usually no more than a few inches. Present and anticipated applications include contactless transactions, data exchange, and simplified setup of more complex communications such as Wi-Fi.

Often, a plurality of parties that work in a restaurant need to communicate with each other and know what everyone is doing to create a smoother operation. Wireless technology, such as RFID and NFC help tie people and organizations together.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a block diagram with an exemplary plurality of parties interacting in an exemplary workflow system, in accordance with an embodiment of the present invention;

FIG. 2 illustrates a flowchart diagram of exemplary steps in a restaurant workflow system, in accordance with an embodiment of the present invention;

FIGS. 3A, 3B, 3C, and 3D illustrates an exemplary robot serving an exemplary order in a restaurant, where FIG. 3A illustrates an exemplary robot following a predetermined route, FIG. 3B illustrates an exemplary serving portion, FIG. 3C illustrates an exemplary self-balancing basket to hold an ordered item, and FIG. 3D illustrates a client receiving an exemplary order from an exemplary robot, accordance with an embodiment of the present invention; and

FIG. 4 illustrates a typical computer system that, when appropriately configured or designed, can serve as an exemplary workflow system, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

Those of skill in the art will appreciate that where appropriate, some embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Where appropriate, embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

“Software” may refer to prescribed rules to operate a computer. Examples of software may include: tag segments in one or more computer-readable languages; graphical and or/textual instructions; applets; pre-compiled tag; interpreted tag; compiled tag; and computer programs.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software program tag for carrying out operations for aspects of the present invention can be written in any combination of one or more suitable programming languages, including an object oriented programming languages and/or conventional procedural programming languages, and/or programming languages such as, for example, Hyper text Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Smalltalk, Perl, UNIX Shell, Visual Basic or Visual Basic Script, Virtual Reality Markup Language (VRML), ColdFusion™ or other compilers, assemblers, interpreters or other computer languages or platforms.

Computer program tag for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program tag may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

A network is a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between computer users. Hundreds of millions of people around the world have access to computers connected to the Internet via Internet Service Providers (ISPs). Content providers (e.g., website owners or operators) place multimedia information (e.g., text, graphics, audio, video, animation, and other forms of data) at specific locations on the Internet referred to as webpages. Websites comprise a collection of connected, or otherwise related, webpages. The combination of all the websites and their corresponding webpages on the Internet is generally known as the World Wide Web (WWW) or simply the Web.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of tag, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed general purpose computers and computing devices. Typically a processor (e.g., a microprocessor) will receive instructions from a memory or like device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The functionality and/or the features of a device may be alternatively embodied by one or more other devices which are not explicitly described as having such functionality/features. Thus, other embodiments of the present invention need not include the device itself.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G.

Where databases are described, it will be understood by one of ordinary skill in the art that (i) alternative database structures to those described may be readily employed, (ii) other memory structures besides databases may be readily employed. Any schematic illustrations and accompanying descriptions of any sample databases presented herein are exemplary arrangements for stored representations of information. Any number of other arrangements may be employed besides those suggested by the tables shown. Similarly, any illustrated entries of the databases represent exemplary information only; those skilled in the art will understand that the number and content of the entries can be different from those illustrated herein. Further, despite any depiction of the databases as tables, an object-based model could be used to store and manipulate the data types of the present invention and likewise, object methods or behaviors can be used to implement the processes of the present invention.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

As used herein, the “client-side” application should be broadly construed to refer to an application, a page associated with that application, or some other resource or function invoked by a client-side request to the application. A “browser” as used herein is not intended to refer to any specific browser (e.g., Internet Explorer, Safari, FireFox, or the like), but should be broadly construed to refer to any client-side rendering engine that can access and display Internet-accessible resources. A “rich” client typically refers to a non-HTTP based client-side application, such as an SSH or CFIS client. Further, while typically the client-server interactions occur using HTTP, this is not a limitation either. The client server interaction may be formatted to conform to the Simple Object Access Protocol (SOAP) and travel over HTTP (over the public Internet), FTP, or any other reliable transport mechanism (such as IBM® MQSeries® technologies and CORBA, for transport over an enterprise intranet) may be used. Any application or functionality described herein may be implemented as native tag, by providing hooks into another application, by facilitating use of the mechanism as a plug-in, by linking to the mechanism, and the like.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

More specifically, as will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-tag, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program tag embodied thereon.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program tag means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

While a non-transitory computer readable medium includes, but is not limited to, a hard drive, compact disc, flash memory, volatile memory, random access memory, magnetic memory, optical memory, semiconductor based memory, phase change memory, optical memory, periodically refreshed memory, and the like; the non-transitory computer readable medium, however, does not include a pure transitory signal per se; i.e., where the medium itself is transitory.

The present invention will now be described in detail with reference to embodiments thereof as illustrated in the accompanying drawings.

There are various types of workflow systems that may be provided by preferred embodiments of the present invention. In one embodiment of the present invention, the workflow system may utilize a communication system having wireless technology to help streamline a sequence of connected steps between a plurality of parties in an organization. The plurality of parties may have different, but interconnected roles. The communication system may be configured to at least partially enable communication between the plurality of parties. Each party has a role in an organization. Each party comprises an attribute for defining the role. The attribute may include a function, a position, and a location of the party. Additionally, each party has a tag for identifying and accessing the attribute. The tag may include a radio frequency identification (RFID) tag. The RFID may allow for wireless non-contact use of radio-frequency electromagnetic fields to transfer data between the plurality of parties in the organization and a data storage portion. In one embodiment, the data storage portion stores the attribute. The attribute is operable to be accessed by at least one party. The attribute is further operable to be viewed by predetermined parties through a communication device. In one embodiment, a scanning device scans the tag to access and view the attribute.

In one embodiment of the present invention, the workflow system may utilize a communication system having wireless technology to help streamline a sequence of connected steps between a plurality of parties in an organization. The plurality of parties may have different, but interconnected roles. In some embodiments, the workflow system may be operable to improve a workflow, reduce chaotic situations, and save time for the plurality of users. The organization may include, without limitation, a restaurant, a hotel, a retail store, and a supply chain. The workflow system may be applied to any organization that has a plurality of parties working in coordination towards a common objective. In one embodiment, service locations with point-of-sale computers or mobile point-of-sale systems may utilize the workflow system.

In one embodiment of the present invention, a communication system utilized in the workflow system may comprise radio frequency identification (RFID) technology. The RFID may allow for wireless non-contact use of radio-frequency electromagnetic fields to transfer data between a plurality of parties in the organization and a data storage portion. In other embodiments, other technologies, including, without limitation, bar tags, Quick Response tags, and scanner may also be integrated and supported in the workflow system. Additionally, the communication system may utilize near field communications (NFC) between various communication devices utilized by the parties to establish radio communication with each other by touching them together or bringing them into close proximity. However, in other embodiments, other technologies may allow the parties to interact wirelessly, or with cable to enhance steps in the workflow. All of the steps may occur remotely and independently of each other, whereby each party has a communication device to view a pertinent step of the workflow. Each party may also have an RFID tag to help identify when, where, and how a step in the workflow has been completed. In some embodiments, the RFID tags may be configured into any shapes or forms produced, including, without limitation, stickers, key chain tags, bracelets, smart phone built-in NFC, labels, cards.

In one embodiment of the present invention, the plurality of parties may each have different, often overlapping roles. The plurality of parties for a restaurant may include, without limitation, a client, a host, a chef, a waiter, a cashier, a delivery person, a busser, a manager, and a robot. The attributes of each party's role may be stored in a data storage portion. The attributes may be accessed from the data storage portion and viewed by scanning a unique RFID tag located on each party. In some embodiments, the attributes associated with each party may include, without limitation, tag location, table location, food preferences, prices, wifi, and server information. A communication device may be carried by each party and used to view the desired attribute. The attribute shown on the communication device may be based on each party's identity and privilege. For example, without limitation, the client may see a menu and input an order with the communication device. The chef may view the order in its unprepared state, while the cashier may view the orders in a completed state. A workflow runtime may be attached to each order. A ticket may consist of orders from the client using a client tag or an NFC communication device. In some embodiments, a sequential ticket number within a defined range may be generated when a client tag is used to place the first order with the ticket number being attached to subsequent orders.

In one embodiment, the workflow system may be utilized in a restaurant for placing, preparing, delivering, and paying for an order. The complete workflow may also be overseen and managed by a manager. In one embodiment, the workflow system may allow a client to remotely place an order to the restaurant. A chef at the restaurant may receive the order and lock the order in for preparation. For example, without limitation, in a kitchen, a chef may receive an order either directly from a client, or from a waiter serving the client. The chef may then lock in the order and commence preparing it. The status of the locked order may be viewed by both the waiter and the client. However, the client may modify the order before the order is locked by the chef. The client may further view the chef through a real time video stream as the chef prepares the order. If the client has not arrived at the restaurant while the order is still being prepared, a host may monitor the client remotely and expect the client at a predetermined time for seating. A waiter may be notified when the order is ready to be taken to the client. A cashier may receive the cost of the order for processing. A busser may be notified when the client has paid and left the table. In one embodiment, the workflow for an order delivery fleet may also be enhanced. For example, without limitation, the dispatch of order delivery to the client's residence may be performed by the manager, cashier, or fleet members by locking the order. A positioning map and routing support may be added to the delivery application. The delivery fleet may communicate to other parties while connected to the data storage portion. A credit card charging and printing of receipts may be done by the fleet using a mobile credit card reader and NFC smartphone.

In one embodiment, a robot may be utilized in place of a person for any of the plurality of parties. The robot may have the RFID tag, and communicate with the appropriate party in the workflow. In one example, the robot may perform the duties of the waiter. In this embodiment, the robot may follow a predetermined path to the client. At least one serving receptacle may contain the order for transport from the chef to the client. The client may then take the desired order off the appropriate serving receptacle. The robot may ensure that the client's order is correct by inquiring in a human voice. The robot may also communicate with the cashier to process the bill.

In some embodiments, the workflow system may also allow a manager to manage and define a series of tasks within the restaurant to produce a final outcome or outcomes. For example, without limitation, the manager may monitor the entire ordering process from initial order to final paying and cleaning the table. The manager may also control shift management for the parties working in the restaurant with the workflow system. Additionally, a staff log of work history may be recording for access and used by the manager to track and regulate compensation and shift management.

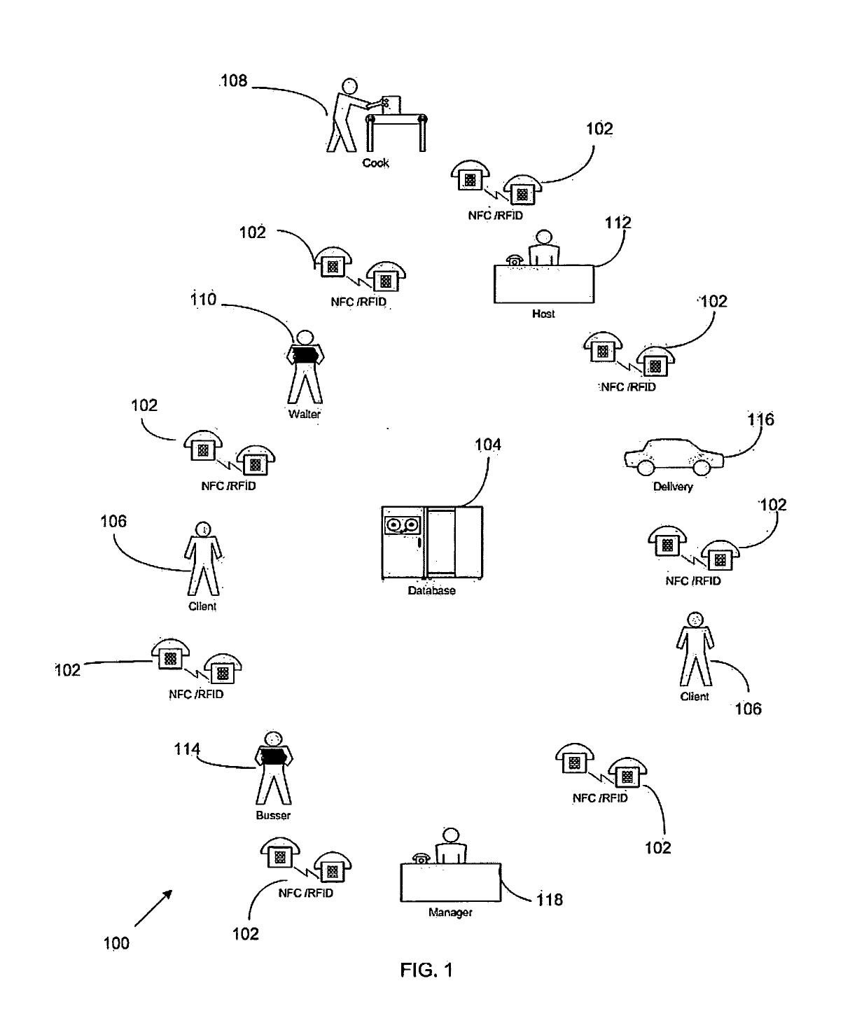

FIG. 1 illustrates a block diagram with an exemplary plurality of parties interacting in an exemplary workflow system, in accordance with an embodiment of the present invention. In one embodiment of the present invention, a workflow system 100 may utilize a communication system 102 having wireless technology to help streamline a sequence of connected steps between a plurality of parties in an organization. The wireless technology may include, without limitation, a radio frequency identification (RFID) technology and/or a smart phone with near field communication technology. In some embodiments, the workflow system may be operable to improve a workflow, reduces chaotic situations, and save time for the plurality of users. The plurality of parties may have different, but interconnected roles. The communication system is configured to at least partially enable communication between the plurality of parties.

In some embodiments, each party may have a role in an organization. For example, without limitation, a role of a chef, or a waiter, or a client. Each party comprises an attribute for defining the role. The attribute may include a function, a position, and a location of the party. Additionally, each party may include a tag for identifying and accessing the attribute. The tag may include a radio frequency identification (RFID) tag. However in some embodiments, NFC technology with a smart phone may also be used. The RFID tag may allow for wireless non-contact use of radio-frequency electromagnetic fields to transfer data between the plurality of parties in the organization and a data storage portion. In one embodiment, the data storage portion stores the attribute. The data storage portion may include, without limitation, a remote server, a data base, a USB, and a cloud. The attribute is operable to be accessed by at least one party. The attribute is further operable to be viewed by predetermined parties through a communication device. In one embodiment, a scanning device scans the tag to access and view the attribute.

In some embodiments, the plurality of parties may have different, but interconnected roles in an organization. The workflow system may be applied to any organization that has a plurality of parties working in coordination towards a common objective. The organization may include, without limitation, a restaurant, a hotel, a retail store, and a supply chain. For example, without limitation, the restaurant may utilize the workflow system to enhance menu ordering and staff management. A hospitality organization may utilize the workflow system with hotel room tablets, room services, and hotel management. A retail store may utilize the workflow system for item catalogues, for sale item promotion, advertising, item purchase, and inventory management. And a supply chain may utilize the workflow system for order management.

In one embodiment of the present invention, the communication system utilized in the workflow system may comprise radio frequency identification (RFID). The RFID may allow for wireless non-contact use of radio-frequency electromagnetic fields to transfer data between a plurality of parties in the organization and a data storage portion. Additionally, the communication system may utilize near field communications (NFC) between various communication devices utilized by the parties to establish radio communication with each other by touching them together or bringing them into close proximity. However, in other embodiments, other technologies may allow the plurality of parties to interact wirelessly, or with cable to enhance steps in the workflow. All of the steps may occur remotely and independently of each other, whereby each party has a communication device to view a pertinent step of the workflow. Each party may also have an RFID tag to help identify when, where, and how a step in the workflow has been completed.

In one embodiment of the present invention, each party may have different and often overlapping roles. The plurality of parties for a restaurant may include, without limitation, a client 106, a chef 108, a waiter 110, a host 112, a busser 114, an order delivery fleet 116, a manager 118, a cashier, and a robot. However, in other embodiments, additional parties may include, without limitation, food supplier, food preparers. Additionally, inventory management subsystem may be added to the workflow. The attributes of each role may be stored in a data storage portion 104. The attribute may be accessed from the data storage portion and viewed by scanning a unique RFID tag located on each party. In some embodiments, the attributes associated with each party may include, without limitation, a party location, and a party job title, and a party function, and, a table location, and a food preference, and a price, and a wifi, and a server information, and an organization attribute.

In one embodiment, a communication device may be carried by each party and used to view the desired attribute. The attribute shown on the communication device may be based on each party's identity and privilege. For example, without limitation, the client may view a menu and input an order with the communication device. The chef may view the order in its unprepared state, while the cashier may view the orders in a completed state. An order runtime may be attached to each order to help monitor and regulate the speed and accuracy of the order. The order runtime may join with a Web Socket. A ticket may consist of orders from the client using a client tag or an NFC communication device. In some embodiments, a sequential ticket number within a defined range may be generated when a client tag is used to place the first order with the ticket number being attached to subsequent orders.

In some embodiments, each party may have a unique role and a place in the workflow. For example, without limitation, a software application of the workflow system may provides the following functions to the client role: read the client's NFC/RFID tags or NFC smart phone for identification, read store tags for Wi-Fi, server, web address and location information, show restaurant menu items for ordering, send each order with options to the server, show current ticket total including tips and taxes, reads the waiter's NFC/RFID tags or NFC smart phone to associate the service provided, allow modification to an order before being locked by the chef, summon the waiter and submit comment to the server, provide personal information to register with the restaurant, pay online or send command for a printed check, utilize the NFC smart phone person-to-person (P2P) communication to transfer the order, post client feedback to social media websites, accept client coupon tags and offer discounts, view commercial videos, and view a live video feed of the chef preparing the order.

In some embodiments, the software application of the workflow system may provides the following functions to the chef role: read the chef's NFC/RFID tags or NFC smart phone to login, allow manual login without using NFC/RFID, view orders and details of all clients, allow locking on an individual order for preparation and send notification to the client, waiter, cashier, and manager, allow force unlocking of orders already locked by other chefs, allow locked orders to be prepared, allow prepared orders to be removed from the list and notification sent to the waiter or order delivery fleet for delivery, facilitate coordination between multiple chefs in one kitchen, and supports live video streaming.

In some embodiments, the software application of the workflow system may provides the following functions to the cashier role: read the cashier's NFC/RFID tags or NFC smart phone to login, allow manual login without using the NFC/RFID tags, shows all orders being locked and unpaid, read the client's NFC/RFID tags or NFC smart phone to bring up the ticket associated, charging the client's credit card for the whole ticket, allow an order to be paid out of a ticket, and send a transaction to the server for archiving and reports.

In some embodiments, the software application of the workflow system may provides the following functions to the manager role: read the cashier's NFC/RFID tags or NFC smart phone to login, receive notification on abnormal situations, e.g. an order taking too long to be prepared, allow voiding an order or charge or provide special discount, shows current staff status and shift information, assigns orders to be delivered by the order delivery fleet, manage staff NFC/RFID tags, create store tags, create and manage coupon tags, manage menu items and categories, and update menu photos and information.

In some embodiments, the software application of the workflow system may provides the following functions to the waiter role: reads the cashier's NFC/RFID tags or NFC smart phone to login, receive notification from the chef, the client, and the manager, show all orders of the clients, allow ordering or changing orders for the client, accept payment from the client, print receipts for a ticket, and respond back to a notification once task is completed.

In some embodiments, the software application of the workflow system may provides the following functions to the order delivery fleet role: read the cashier's NFC/RFID tags or NFC smart phone to login, locks orders that need to be delivered, shows orders to be delivered and mapping to all destinations, allow delivery sequence arranging and rerouting, sends current location back to the waiter for tracking, communicate to other order delivery fleet members, accept payment from the client, print receipts for a ticket.

In some embodiments, the software application of the workflow system may provides the following functions to the data storage portion: listen to socket connections from role applications and support application requests, store all role account information and transactions in a server database, execute runtime tags of all workflows, provide a Wi-Fi hot spot, provide a client socket connection to a master workflow server, and locate on the premise or remotely, store and provide CRM information of individual stores, restaurants and their clients, provide geo-location information provided by the mobile device to the master workflow server to receive and store information, including, without limitation, Wi-Fi info, store workflow server IP address, exact address and proximal organizations.

In some embodiments, the software application of the workflow system may provides the following functions to a website for the organization: display the menu, receive orders, display information on the organization, connect to the data storage portion to obtain information, allow credit card charging and prepay services, allow the client to login to review order history, display business reports to the manager, create new menu categories and items, update menu photos and information, and provide CRM user interface for the data storage portion.

In some embodiments, the software application of the workflow system may provides the following functions to for managing the software program for the workflow system: read the cashier or manager NFC/RFID tags or NFC smart phone to login, read the client NFC/RFID tags or NFC smart phone to bring up a ticket, POS functions, report functions, Wi-Fi hot spot function, staff and shift management, assists with workflow server upgrade, sends local database to a support team, and display messages and manage the data storage portion.

In one embodiment of the present invention, the workflow system may utilize the data storage portion to accept socket connections from the communication device of the client. The communication device may include, without limitation, a mobile device application that supports all major operating systems for the client, the waiter, the chef, the cashier and the manager. The communication device may further include a separate mobile application just for a delivery fleet. The data storage portion may include a workflow server with a built-in web server that can host a restaurant website for informational purpose and also supports ordering via web pages. The workflow server may have hot spot function to provide free Wi-Fi access to the client. In some embodiments, a captive portal router can be added to direct all client web traffic to the website for ordering. Those skilled in the art, in light of the present teachings, will recognize that the same workflow server may be used at a remote location that accepts connections from restaurant workflow servers. They are considered clients to this master server. Thus creates a server farm. The master server may be used to maintain restaurant and their client records for better marketing and provide extra services to clients. In some embodiments, the client may register personal information to the master server using the mobile application or website. With the client's approval, the application may post their restaurant experience to social media websites, including, without limitation, Facebook™, Tweeter™, and Google+™. The restaurant may offer discount incentive for the clients to do so.

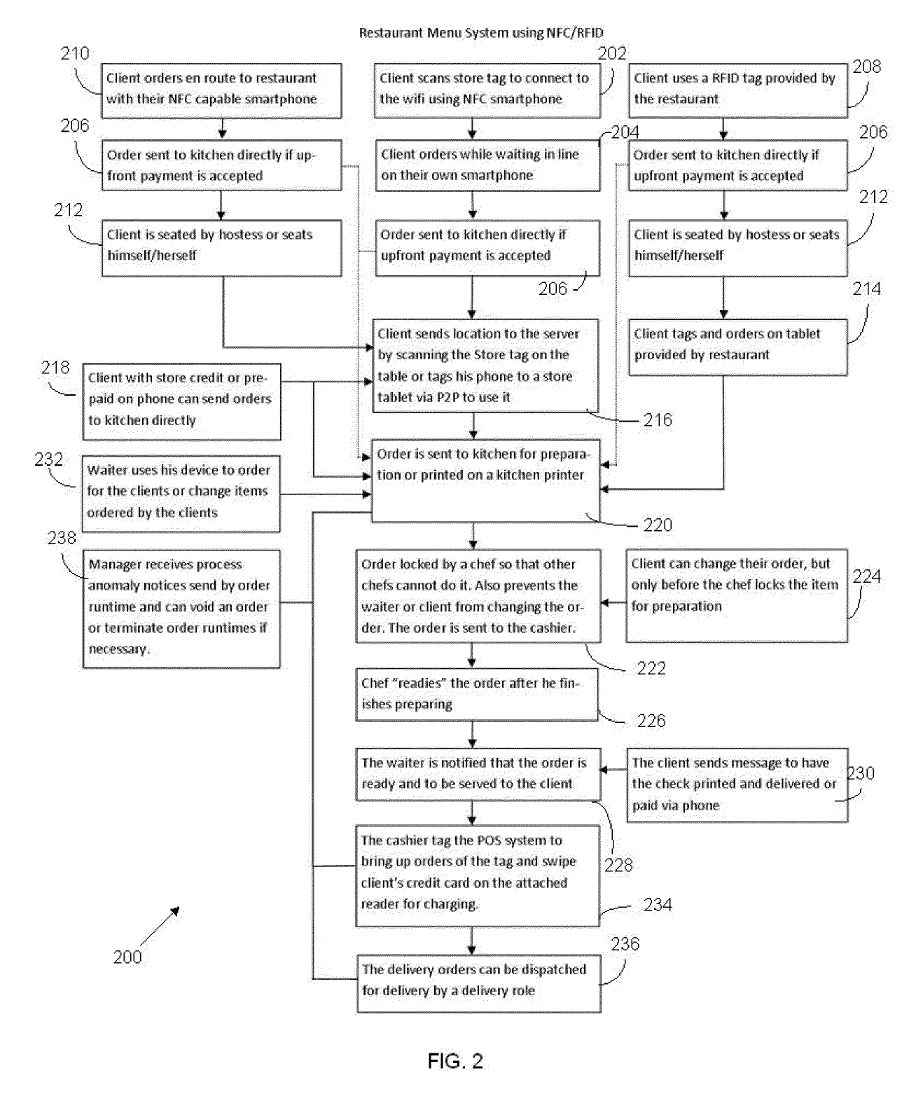

FIG. 2 illustrates a flowchart diagram of exemplary steps in a restaurant workflow system, in accordance with an embodiment of the present invention. In the present invention, the workflow system may be utilized in a restaurant for placing, preparing, delivering, and paying for an order. The complete workflow may also be overseen and managed by a manager. The workflow system may utilize a workflow process 200 comprising of sequential steps for performing the desired function.

Initially, the client may perform a Step 202 of scanning an RFID tag with an NFC smart phone for the organization. A Step 204 may allow the client to order while waiting in line on the smart phone. If upfront payment is accepted, a Step 206 may allow the order to be sent directly to the chef in the kitchen.

In some embodiments, a Step 208 may allow the client to utilize an RFID tag provided by the restaurant. If upfront payment is accepted, Step 206 may allow the order to be sent directly to the chef in the kitchen. A Step 212 may allow the client to take a seat in the restaurant alone or with the help of the waiter. The client may be seated with a table occupancy map that is visible on a computer screen for the host. The host may set the occupancy attribute of an available table for the client before leading the client of the appropriate table. The client may order on a tablet provided by the restaurant in a Step 214.

A Step 210 may enable the client to place an order from an NFC smart phone en route to the restaurant. Those skilled in the art will recognize that if the smart phone is not NFC enabled, a system issued ticket number may be used to refer to the order. If upfront payment is accepted, Step 206 may allow the order to be sent directly to the chef in the kitchen. A Step 212 may allow the client to take a seat in the restaurant alone or with the help of the waiter. A Step 232 may allow the waiter to order for the client or change the order.

In some embodiments, after the client places the order and waits, a Step 216 may allow the client to scan a restaurant RFID tag to send the position of the client relative to the restaurant to the data storage portion. The data storage portion may then relay the position of the client to the pertinent parties in the restaurant. For example, the host may know when the client is arriving to prepare a table. If the client has not arrived at the restaurant while the order is still being prepared, a host may monitor the client remotely and expect the client at a predetermined time for seating. However, in another embodiment, a Step 218 may allow the client with a credit card or prepaid phone credit to send orders to the kitchen directly.

In some embodiments, a Step 220 allows the order to be sent to the kitchen directly or printed on a kitchen printer. A Step 222 may allow the chef at the restaurant to receive the order and lock the order in for preparation. For example, without limitation, in a restaurant, a chef may receive an order either directly from a client, or from a waiter serving the client. The chef may then lock in the order and commence preparing it. The status of the locked order may be viewed by both the waiter and the client. The workflow system may further facilitate coordination between multiple chefs in one kitchen by allowing them to view each other remotely, and know what stage the order is at. The order is also sent to the cashier in this step. The cashier may receive the cost of the order for processing. However, in a Step 224, the client may modify the order before the order is locked by the chef. The client may further view the chef through a real time video stream as the chef prepares the order.

A Step 226 may require the chef to prepare the order. A Step 228 may allow the waiter to receive notification from the chef that the order is ready. In Step 230, the client may send notification through the communication device to print and receive the bill. In a Step 234, the cashier may receive and swipe a credit card from the client at a point of sale. In some embodiments, a Step 238 may allow the manager to receive order anomalies in the order runtime and terminate the order. Finally, the busser may be notified when the client has paid and left the table. The busser may then scan a table RFID tag to reset the attribute after cleaning the table to indicate the table is available again.

In one embodiment, a Step 236 may allow the order delivery to be dispatched. For example, without limitation, the dispatch of order delivery to the client's residence may be performed by the manager, cashier, or fleet members by locking the order. A positioning map and routing support may be added to the delivery application. The delivery fleet may communicate to other parties while connected to the data storage portion. A credit card charging and printing of receipts may be done by the fleet using a mobile credit card reader and NFC smartphone.

In some embodiments, the workflow system may also allow a manager to manage and define a series of tasks within the restaurant to produce a final outcome or outcomes. For example, without limitation, the manager may monitor the entire ordering process from initial order to final paying and cleaning the table. The manager may also control shift management for the parties working in the restaurant with the workflow system. Additionally, a staff log of work history may be recording for access and used by the manager to track and regulate compensation and shift management.

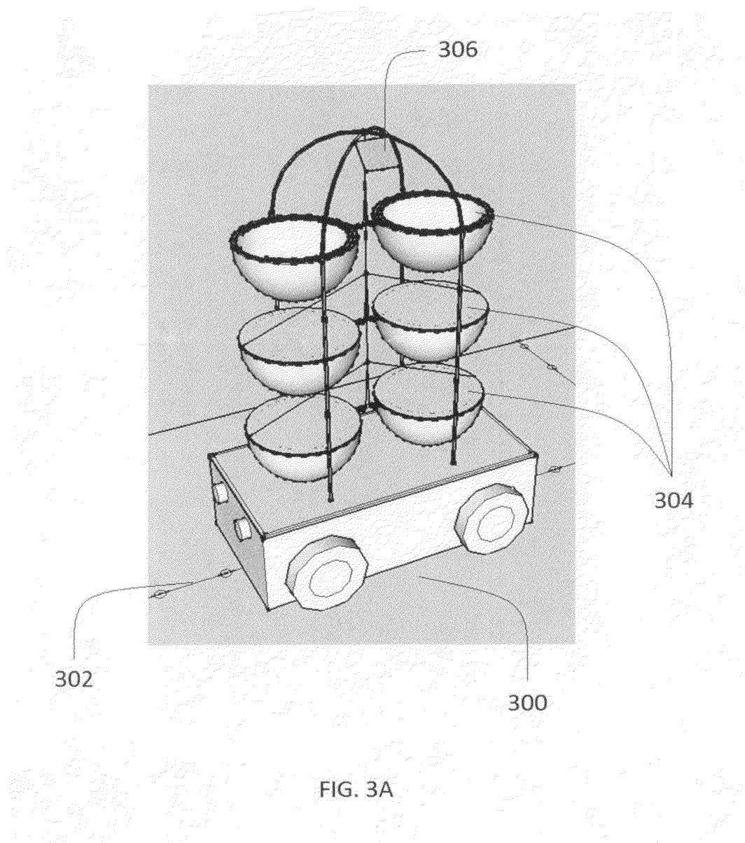

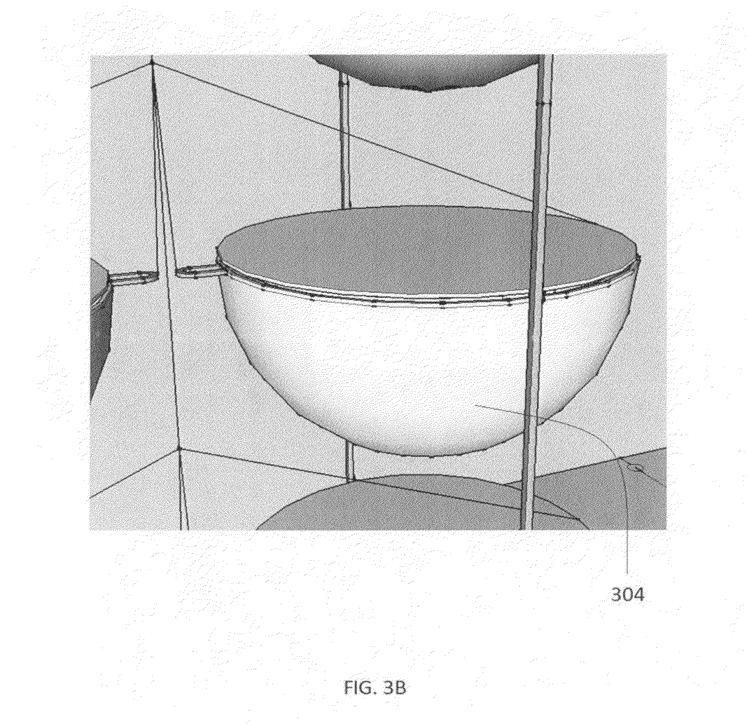

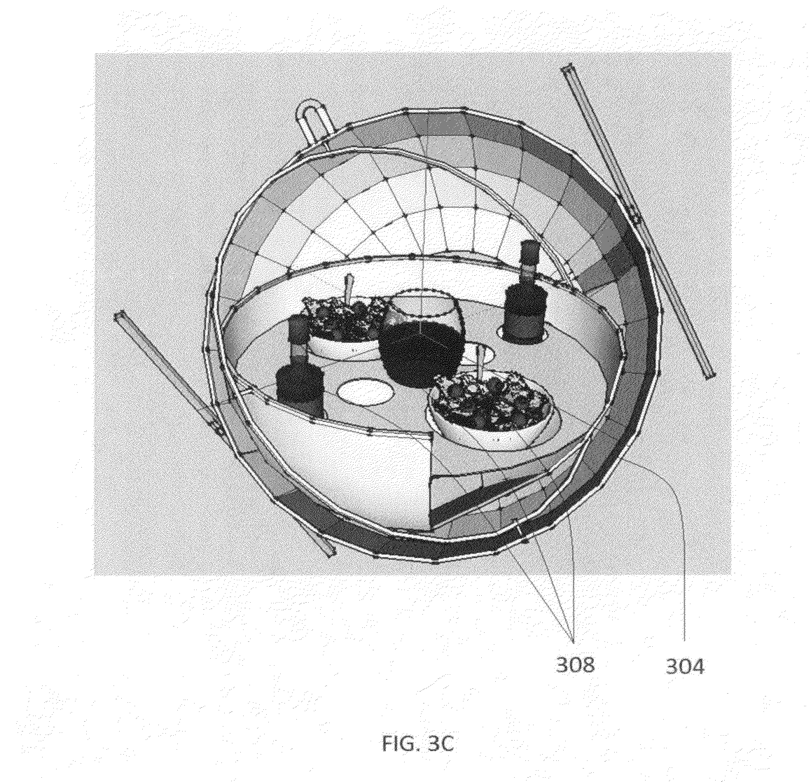

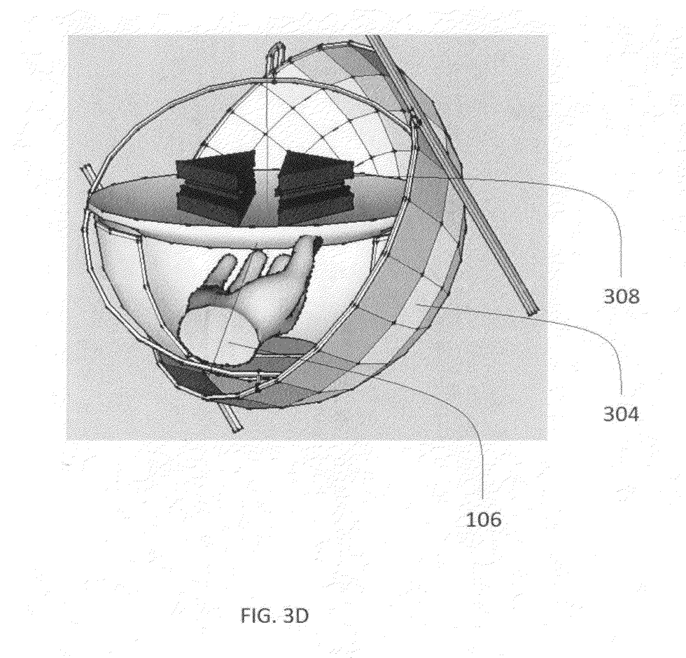

FIGS. 3A, 3B, 3C, and 3D illustrates an exemplary robot serving an exemplary order in a restaurant, where FIG. 3A illustrates an exemplary robot following a predetermined route, FIG. 3B illustrates an exemplary serving portion, FIG. 3C illustrates an exemplary self-balancing basket to hold an ordered item, and FIG. 3D illustrates a client receiving an exemplary order from an exemplary robot, accordance with an embodiment of the present invention. In the present invention, a robot 300 may be used in place of any of the plurality of parties. The robot may have an RFID tag, and communicate with the appropriate party with a robot communication device 306. In one example, the robot may perform the duties of the waiter. In this embodiment, the robot may follow a predetermined path 302 to the client while carrying an order 308 to the client. At least one serving receptacle 304 may contain the order during transport from the chef to the client. The at least one serving receptacle including, without limitation, a mechanically self-balancing order holding basket, a tray, and a dish. The client may take the desired order off of the appropriate serving receptacle. The robot may ensure that the client's order is correct by inquiring in a human voice. The robot may also utilize the robot communication device to communicate with the cashier through RFID and NFC technology for processing the bill. In some embodiments, the cashier may also be a robot.

In one alternative embodiment, the workflow system may be utilized in a factory to help coordinate the movement of parts from a warehouse to the assembly line. In yet another alternative embodiment, a bar tag may be utilized in the restaurant, rather than an RFID tag. In yet another alternative embodiment, the client may send a robot to pick up an order, whereby the client preloads the order into the robot. In yet another alternative embodiment, the manager may receive stored information from the data storage portion that is unique to the client. In this manner, the manager may send promotions and food specials that the client has a history of utilizing.

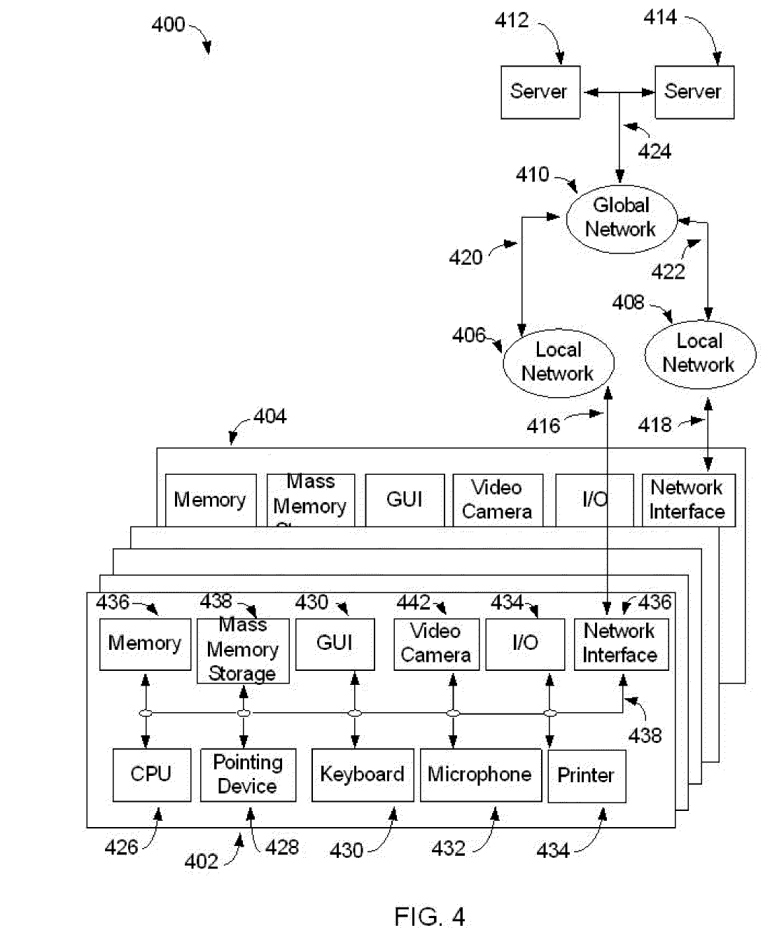

FIG. 4 illustrates a typical computer system that, when appropriately configured or designed, can serve as an exemplary workflow system, in accordance with an embodiment of the present invention. In the present invention. A communication system 400 includes a multiplicity of clients with a sampling of clients denoted as a client 402 and a client 404, a multiplicity of local networks with a sampling of networks denoted as a local network 406 and a local network 408, a global network 410 and a multiplicity of servers with a sampling of servers denoted as a server 412 and a server 414.

Client 402 may communicate bi-directionally with local network 406 via a communication channel 416. Client 404 may communicate bi-directionally with local network 408 via a communication channel 418. Local network 406 may communicate bi-directionally with global network 410 via a communication channel 420. Local network 408 may communicate bi-directionally with global network 410 via a communication channel 422. Global network 410 may communicate bi-directionally with server 412 and server 414 via a communication channel 424. Server 412 and server 414 may communicate bi-directionally with each other via communication channel 424. Furthermore, clients 402, 404, local networks 406, 408, global network 410 and servers 412, 414 may each communicate bi-directionally with each other.

In one embodiment, global network 410 may operate as the Internet. It will be understood by those skilled in the art that communication system 400 may take many different forms. Non-limiting examples of forms for communication system 400 include local area networks (LANs), wide area networks (WANs), wired telephone networks, wireless networks, or any other network supporting data communication between respective entities.

Clients 402 and 404 may take many different forms. Non-limiting examples of clients 402 and 404 include personal computers, personal digital assistants (PDAs), cellular phones and smartphones.

Client 402 includes a CPU 426, a pointing device 428, a keyboard 430, a microphone 432, a printer 434, a memory 436, a mass memory storage 438, a GUI 440, a video camera 442, an input/output interface 444 and a network interface 446.

CPU 426, pointing device 428, keyboard 430, microphone 432, printer 434, memory 436, mass memory storage 438, GUI 440, video camera 442, input/output interface 444 and network interface 446 may communicate in a unidirectional manner or a bi-directional manner with each other via a communication channel 448. Communication channel 448 may be configured as a single communication channel or a multiplicity of communication channels.

CPU 426 may be comprised of a single processor or multiple processors. CPU 426 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 436 is used typically to transfer data and instructions to CPU 426 in a bi-directional manner. Memory 436, as discussed previously, may include any suitable computer-readable media, intended for data storage, such as those described above excluding any wired or wireless transmissions unless specifically noted. Mass memory storage 438 may also be coupled bi-directionally to CPU 426 and provides additional data storage capacity and may include any of the computer-readable media described above. Mass memory storage 438 may be used to store programs, data and the like and is typically a secondary storage medium such as a hard disk. It will be appreciated that the information retained within mass memory storage 438, may, in appropriate cases, be incorporated in standard fashion as part of memory 436 as virtual memory.

CPU 426 may be coupled to GUI 440. GUI 440 enables a user to view the operation of computer operating system and software. CPU 426 may be coupled to pointing device 428. Non-limiting examples of pointing device 428 include computer mouse, trackball and touchpad. Pointing device 428 enables a user with the capability to maneuver a computer cursor about the viewing area of GUI 440 and select areas or features in the viewing area of GUI 440. CPU 426 may be coupled to keyboard 430. Keyboard 430 enables a user with the capability to input alphanumeric textual information to CPU 426. CPU 426 may be coupled to microphone 432. Microphone 432 enables audio produced by a user to be recorded, processed and communicated by CPU 426. CPU 426 may be connected to printer 434. Printer 434 enables a user with the capability to print information to a sheet of paper. CPU 426 may be connected to video camera 442. Video camera 442 enables video produced or captured by user to be recorded, processed and communicated by CPU 426.

CPU 426 may also be coupled to input/output interface 444 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 426 optionally may be coupled to network interface 446 which enables communication with an external device such as a database or a computer or telecommunications or internet network using an external connection shown generally as communication channel 416, which may be implemented as a hardwired or wireless communications link using suitable conventional technologies. With such a connection, CPU 426 might receive information from the network, or might output information to a network in the course of performing the method steps described in the teachings of the present invention.

Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microtag and the like. For any method steps described in the present application that can be carried out on a computing machine, a typical computer system can, when appropriately configured or designed, serve as a computer system in which those aspects of the invention may be embodied.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing means for and/or steps described that the applications designer will selectively decide, depending upon the practical considerations of the particular implementation, to carry out and/or locate within the jurisdiction of the USA. For example, any of the foregoing described method steps and/or system components which may be performed remotely over a network (e.g., without limitation, a remotely located server) may be performed and/or located outside of the jurisdiction of the USA while the remaining method steps and/or system components (e.g., without limitation, a locally located client) of the forgoing embodiments are typically required to be located/performed in the USA for practical considerations. In client-server architectures, a remotely located server typically generates and transmits required information to a US based client, for use according to the teachings of the present invention. Depending upon the needs of the particular application, it will be readily apparent to those skilled in the art, in light of the teachings of the present invention, which aspects of the present invention can or should be located locally and which can or should be located remotely. Thus, for any claims construction of the following claim limitations that are construed under 35 USC §112 (6) it is intended that the corresponding means for and/or steps for carrying out the claimed function are the ones that are locally implemented within the jurisdiction of the USA, while the remaining aspect(s) performed or located remotely outside the USA are not intended to be construed under 35 USC §112 (6).

It is noted that according to USA law, all claims must be set forth as a coherent, cooperating set of limitations that work in functional combination to achieve a useful result as a whole. Accordingly, for any claim having functional limitations interpreted under 35 USC §112 (6) where the embodiment in question is implemented as a client-server system with a remote server located outside of the USA, each such recited function is intended to mean the function of combining, in a logical manner, the information of that claim limitation with at least one other limitation of the claim. For example, in client-server systems where certain information claimed under 35 USC §112 (6) is/(are) dependent on one or more remote servers located outside the USA, it is intended that each such recited function under 35 USC §112 (6) is to be interpreted as the function of the local system receiving the remotely generated information required by a locally implemented claim limitation, wherein the structures and or steps which enable, and breath life into the expression of such functions claimed under 35 USC §112 (6) are the corresponding steps and/or means located within the jurisdiction of the USA that receive and deliver that information to the client (e.g., without limitation, client-side processing and transmission networks in the USA). When this application is prosecuted or patented under a jurisdiction other than the USA, then “USA” in the foregoing should be replaced with the pertinent country or countries or legal organization(s) having enforceable patent infringement jurisdiction over the present application, and “35 USC §112 (6)” should be replaced with the closest corresponding statute in the patent laws of such pertinent country or countries or legal organization(s).

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC §112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, other equivalent or alternative methods of implementing a workflow system that streamlines the work in an organization by tying together all the parties involved in the work according to the present invention will be apparent to those skilled in the art. Various aspects of the invention have been described above by way of illustration, and the specific embodiments disclosed are not intended to limit the invention to the particular forms disclosed. The particular implementation of the workflow system that streamlines the work in an organization by tying together all the parties involved in the work may vary depending upon the particular context or application. By way of example, and not limitation, the workflow system that streamlines the work in an organization by tying together all the parties involved in the work described in the foregoing were principally directed to coordinating functions between a client and employees at a restaurant to enhance a workflow implementations; however, similar techniques may instead be applied to any organization that has a plurality of parties working in coordination towards a common objective, such as the military, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

The currently pending claims are as follows:

1. A system comprising:
a communication system, said communication system being configured to at least partially enable communication between a plurality of parties, each party being operable to have a role in an organization, each party comprising an attribute for defining said role, said attribute being operable to be accessed by at least one party, said attribute further being operable to be viewed by at least one party;
a data storage portion, said data storage portion being configured to store said attribute;
a tag, said tag being disposed to join with said plurality of parties, said tag being configured to be operatively linked to said data storage portion; and
a scanning device, said scanning device being configured to scan said tag for accessing and viewing said attribute;
wherein said plurality of parties comprise a client, and/or a chef, and/or a waiter, and/or a host, and/or a busser, and/or a cashier, and/or an order delivery fleet, and/or a manager, and/or a robot.

2. The system of claim 1, in which said communication system comprises a wireless technology, said wireless technology comprising a radio frequency identification tag and/or a smart phone with near field communication technology.

3. The system of claim 2, in which said organization comprises a restaurant, and/or a hotel, and/or a retail store.

4. (canceled)

5. The system of claim 3, in which said attribute comprises, a party location, and/or a party job title, and/or a party function, and/or a table location, and/or a food preference, and/or a price, and/or a wifi, and/or a server information, and/or an organization attribute.

6. The system of claim 5, in which said attribute is operable to be viewed through a communication device.

7. The system of claim 6, in which said communication device is configured to display an order from said client.

8. The system of claim 7, in which said communication device is operable to enable said client to view said chef in a kitchen.

9. The system of claim 8, in which said data storage portion comprises an organization location attribute, said organization location attribute being configured to be viewed by scanning an organization tag with a restaurant tablet and/or a smart phone comprising near field communication technology.

10. The system of claim 9, in which said tag is configured to be interchangeable with a smart phone having near field communication technology.

11. The system of claim 10, in which said tag comprises a client tag, said client tag comprising a personal information for said client, said personal information comprising an order history and a client contact information.

12. The system of claim 11, in which said client tag is configured to operatively link with a client food preference attribute, said client tag further being configured to be scanned for displaying a food preference of said client on a digital menu, said digital menu being configured to be viewed by said plurality of parties.

13. The system of claim 12, in which said tag comprises a table occupancy tag, said table occupancy tag being configured to be scanned for identifying availability of a table, said availability being viewable by said host and said waiter.

14. The system of claim 13, wherein said tag comprises a bill tag, said bill tag being configured to be scanned for enabling a plurality of clients to share a bill.

15. The system of claim 14, wherein said system is operable to at least partially enable said waiter to order for said client, and/or receive notification when said order is ready, and/or apply a tip to said bill.

16. The system of claim 15, in which said system is operable to at least partially enable said chef to lock said order, and/or display a status of said locked order to said plurality of parties.

17. The system of claim 16, in which in which said system is operable to at least partially enable said client to modify said order before being locked by said chef, and/or engage with said waiter, and/or request said bill to be printed and delivered, and/or pay said bill.

18. The system of claim 17, in which said system is operable to at least partially enable said manager to regulate said tag for said plurality of parties with a tablet, and/or void said order.

19. A system comprising:
a robot, said robot being configured to at least partially deliver an order to a client and/or a plurality of parties, said robot being operable to follow a predetermined path for delivering said order, said robot comprising a tag, said tag being configured to identify an attribute of said robot;
a robot communication device, said robot communication device being configured to at least partially enable said robot to communicate with said client and/or said plurality of parties by scanning said tag; and
at least one serving receptacle, said at least one serving receptacle being disposed to join with said robot, said at least one serving receptacle being configured to at least partially carry said order for storage and transport along said predetermined path, said at least one serving receptacle being operable to display and serve said order in conjunction with a command from said client and/or said plurality of parties, said at least one serving receptacle comprising a mechanically self-balancing order holding basket, wherein said plurality of parties comprise a client, and/or a chef, and/or a waiter, and/or a host, and/or a busser, and/or a cashier, and/or an order delivery fleet, and/or a manager, and/or a robot.

20. A system consisting of:
a communication system, said communication system comprising a wireless technology, said wireless technology comprising a radio frequency identification tag and/or a smart phone with near field communication technology, said communication system being configured to at least partially enable communication between a plurality of parties, said plurality of parties comprising a client, and/or a chef, and/or a waiter, and/or a host, and/or a busser, and/or a cashier, and/or an order delivery fleet, and/or a manager, and/or a robot, each party being operable to have a role in an organization, said organization comprising a restaurant, and/or a hotel, and/or a retail store, each party comprising an attribute for defining said role, said attribute further comprising, a party location, and/or a party job title, and/or a party function, and/or a table location, and/or a food preference, and/or a price, and/or a wifi, and/or a server information, and/or an organization attribute, said attribute being operable to be accessed by at least one party, said attribute further being operable to be viewed by at least one party, said attribute further being operable to be viewed through a communication device, said communication device being configured to display an order from said client, said communication device being operable to enable said client to view said chef in a kitchen;
a data storage portion, said data storage portion being configured to store said attribute, said data storage portion comprising an organization location attribute, said organization location attribute being configured to be viewed by scanning an organization tag with a restaurant tablet and/or a smart phone comprising near field communication technology;
a tag, said tag being disposed to join with said plurality of parties, said tag being configured to be operatively linked to said data storage portion, said tag being configured to be interchangeable with a smart phone having near field communication technology, said tag comprising a client tag, said client tag comprising personal information for said client, said personal information comprising an order history and a client contact information, said client tag being operatively linked to a client food preference attribute, said client tag being configured to be scanned for displaying a food preference of said client on a digital menu, said digital menu being configured to be viewed by said plurality of parties, said client tag further comprising at least one coupon, said tag further comprising a table occupancy tag, said table occupancy tag being configured to be scanned to identify availability of a table, said availability being viewable by said host and said waiter, said tag further comprising a bill tag, said bill tag being configured to be scanned for enabling a plurality of clients to share a bill, said tag further comprising a chef tag, said chef tag being configured to be scanned for identifying a plurality of chefs for enhancing collaboration between each chef; and
a scanning device, said scanning device being configured to scan said tag for accessing and viewing said attribute, said scanning device comprising a laser scanner,
said system being operable to at least partially enable said waiter to order for said client, and/or receive notification when said order is ready, and/or apply a tip to said bill, said system further being operable to at least partially enable said chef to lock said order, and/or display a status of said locked order to said plurality of parties, said system further being operable to at least partially enable said client to modify said order before being locked by said chef, and/or engage with said waiter, and/or request said bill to be printed and delivered, and/or pay said bill, said system further being operable to at least partially enable said cashier to view and process said bill by scanning said tag and an associated credit card, said system further being operable to at least partially enable said manager to regulate said tag for said plurality of parties with a tablet, and/or void said order, said system further comprising a restaurant staff logon history for enabling said manager to identify compensation data and perform shift management, said system further comprising an order runtime, said order runtime being operable to delete said order after a predetermined duration, said order runtime being configured to join with a Web Socket communication, said Web Socket communication being configured to provide a real time response to a user interaction, wherein said plurality of parties comprise a client, and/or a chef, and/or a waiter, and/or a host, and/or a busser, and/or a cashier, and/or an order delivery fleet, and/or a manager, and/or a robot.
